(19) United States
(12) Patent Application Publication
(10) Pub. No.: US 2016/0282912 A1
(43) Pub. Date: Sep. 29, 2016

(54) MOUNTING DEVICE FOR DATA STORAGE DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: PENG LIU, Wuhan (CN)

(21) Appl. No.: 14/695,665

(22) Filed: Apr. 24, 2015

(30) Foreign Application Priority Data
Mar. 25, 2015 (CN) 201510132594.6

(51) Int. Cl. G06F 1/18; G06F 1/16; G06F 1/20

(52) U.S. Cl. CPC G06F 1/183; G06F 1/20; G06F 1/16

(57) ABSTRACT

A mounting device for a data storage device includes a cover and a case. The cover has a recess. The case includes a top plate and two side plates extending from the top plate. A receiving space is defined cooperatively by the top plate and the side plates, and the receiving space is communicated with the recess. The case further defines an opening, and the data storage device is mountable within the receiving space from the opening with a bottom surface of the data storage device received into the recess.

### CROSS-REFERENCE TO RELATED APPLICATIONS

This application claims priority to Chinese Patent Application No. 201510132594.6 filed on Mar. 25, 2015, the contents of which are hereby incorporated by reference.

### FIELD

The subject matter herein generally relates to a mounting device for a data storage device.

### BACKGROUND

An electronic device with a data storage device generally includes a mounting device for securing the data storage device to a circuit board. The mounting device generally includes a case configured for receiving the data storage device. The data storage device can be removed from the circuit board along with the case.

### BRIEF DESCRIPTION OF THE DRAWINGS

Implementations of the present technology will now be described, by way of example only, with reference to the attached figures.

FIG. 1 is an exploded, isometric view of an embodiment of a mounting device, a data storage device, and a circuit board.

FIG. 2 is a partially assembled, isometric view of the mounting device, the data storage device, and the circuit board of FIG. 1.

FIG. 3 is an assembled, isometric view of the mounting device, the data storage device, and the circuit board of FIG. 1, showing a part of the data storage device extending out of a case.

FIG. 4 is similar to the FIG. 3, but showing the data storage device fully received in the case.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

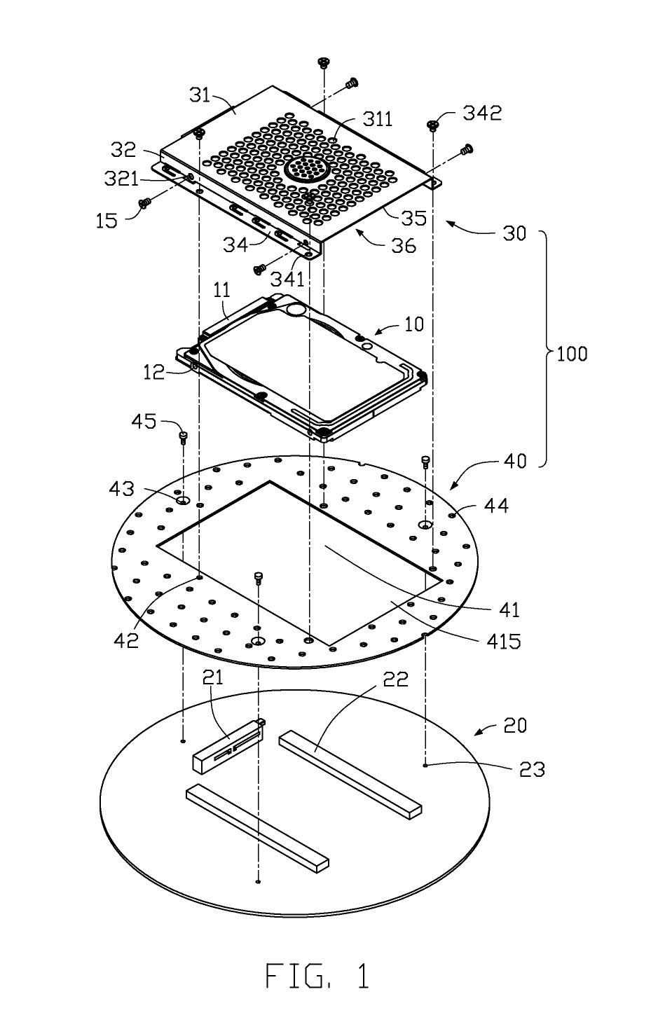

FIG. 1 illustrates an electronic device including a mounting device 100, a data storage device 10, and a circuit board 20 in accordance with an embodiment. The mounting device 100 can include a case 30 and a cover 40.

The data storage device 10 includes a connecting port 11. The circuit board 20 includes a connector 21 corresponding to the connecting port 11. The connector 21 can be coupled to the connecting port 11 to electronically connect the data storage device 10 to the circuit board 20. Each opposite side surface of the data storage device 10 defines two limiting holes 12. A plurality of limiting members 15 can be engaged with the limiting holes 12 through the case 30 to secure the data storage device 10 to the case 30. Two guiding ribs 22 are mounted on the circuit board 20. In at least one embodiment, the two guiding ribs 22 are substantially parallel to each other. Each guiding rib 22 is elastically deformable, when a height of each guiding rib 22 is greater than a height of the data storage device 10, the case 30 can press the guiding ribs 22 to be a same height as the data storage device 10. The circuit board 20 further defines a plurality of mounting holes 23.

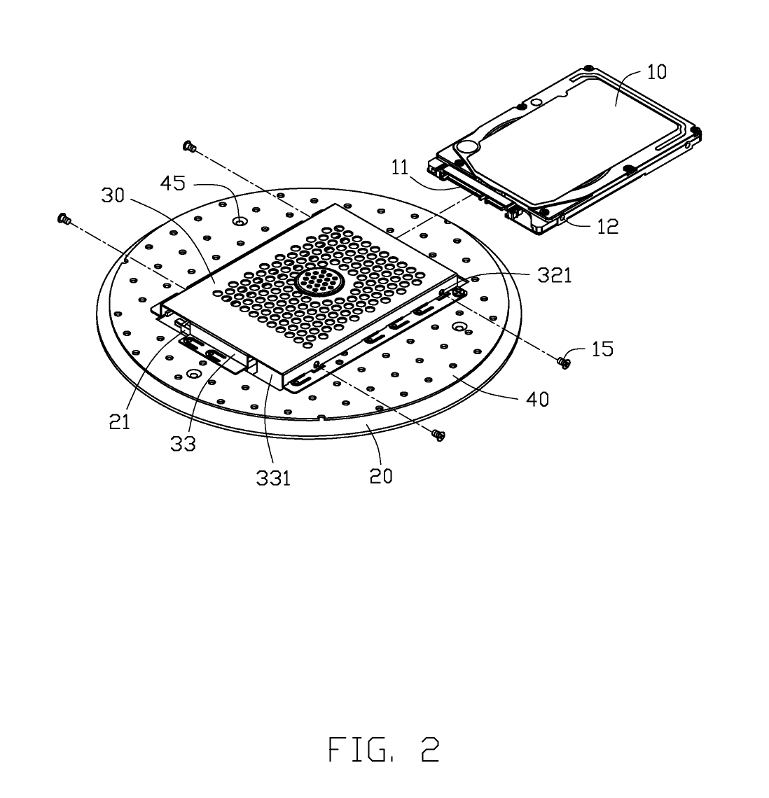

FIG. 1 and FIG. 2 illustrate that the case 30 can include a top plate 31, two side plates 32, and a blocking plate 33 (shown as in FIG. 2). The two side plates 32 are substantially parallel to each other, the top plate 31 is substantially perpendicular to each side plate 32 and the blocking plate 33, and the blocking plate 33 is substantially perpendicular to each side plate 32. The top plate 31, the two side plates 32, and the blocking plate 33 cooperate to define a receiving space 35. The top plate 31 defines a plurality of ventilation holes 311 configured to cool the data storage device 10. Each side plate 32 defines two through holes 321 corresponding to the limiting holes 12. The limiting members 15 can be inserted through the through holes 321. A flange 34 extends from a bottom edge of each side plate 32. The flange 34 defines a plurality of locking holes 341. A plurality of fasteners 342 can be inserted into the cover 40 through the locking holes 341 to secure the case 30 to the cover 40. The blocking plate 33 extends from a side edge of the top plate 31. The connector 21 is received in the receiving space 35 and abuts against the blocking plate 33. A length of the blocking plate 33 is less than a distance between the two side plates 32, and a cutout 331 is defined between each side plate 32 and a side edge of the blocking plate 33. The cutout 331 is configured for a user to push the data storage device 10 out through the receiving space 35. An opening 36, opposite to the blocking plate 33, is defined by the case 30.

The cover 40 defines a recess 41. The recess 41 has a yielding portion 415. A length of the recess 41 is greater than a length of the top plate 31. The cover 40 further defines a plurality of positioning holes 42 and ventilation holes 44 surrounding the recess 41. The fasteners 342 can inserted into the positioning holes 42 through the locking holes 341 to secure the case 30 to the cover 40. A plurality of mounting posts 43 is located on the cover 40. A plurality of mounting members 45 can be inserted into the mounting holes 23 through the mounting posts 43 to secure the cover 40 to the circuit board 20.

FIG. 2 illustrates in assembly, the cover 40 is placed on the circuit board 20 with the connector 21 and the guiding ribs 22 received in the recess 41, and the mounting posts 43 are aligned with the mounting holes 23. The mounting members 45 are inserted into the mounting holes 23 through the mounting posts, securing the cover 40 to the circuit board 20. The case 30 is moved on the cover 40 with the receiving space aligned with the recess 41, the locking holes 341 aligned with the positioning holes 42. The fasteners 342 are inserted into the positioning holes 42 through the locking holes 341, securing the case 30 to the cover 40. The yielding portion 415 is exposed out of the receiving space 35 and located outside of the case 30.

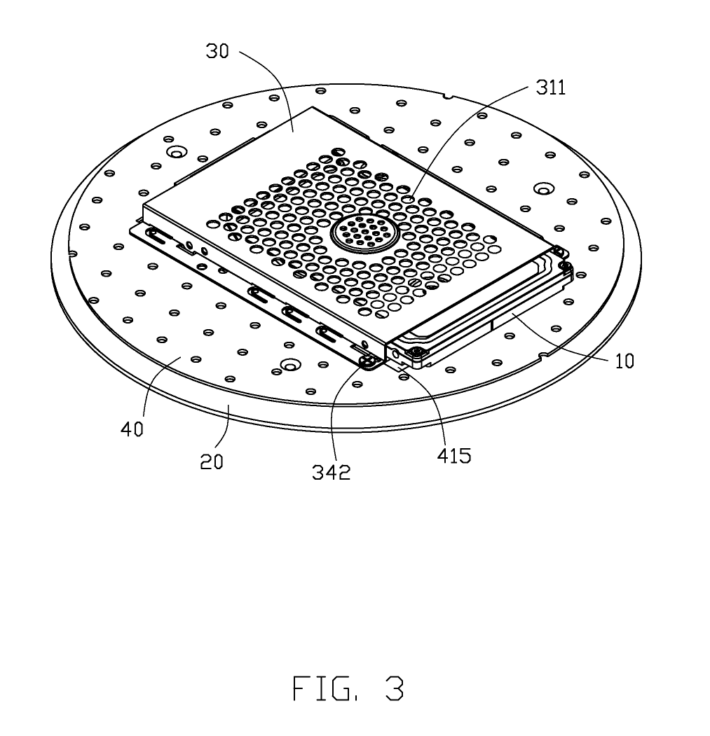

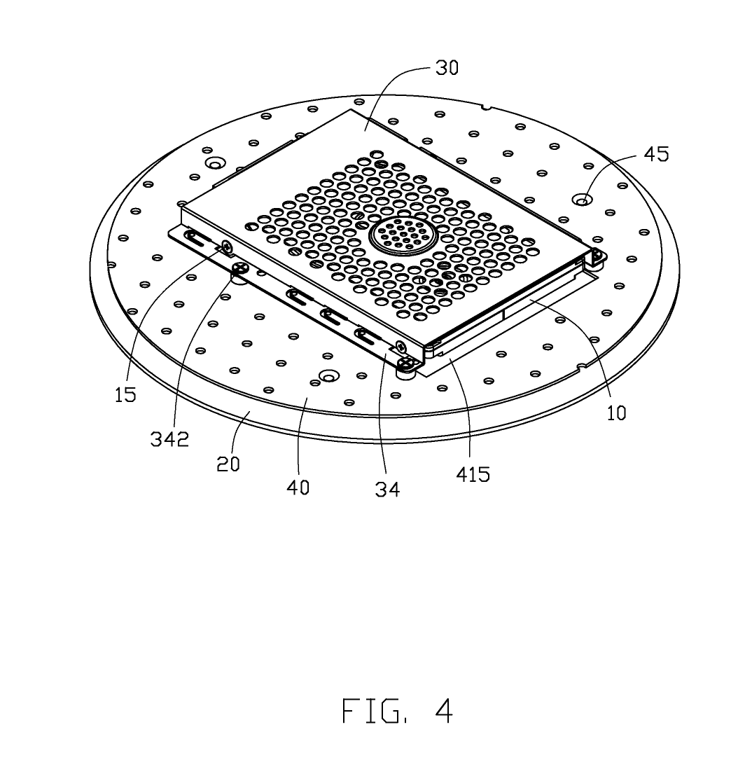

FIG. 3 and FIG. 4 illustrate in assembly of the data storage device 10, the data storage device 10 is placed between the two guiding ribs 22 and aligned with the opening 36. The data storage device 10 is pushed into the receiving space 35 towards the connector 21 until the connecting port 11 is coupled to the connector 21 and the limiting holes 12 are aligned with the through holes 12. The limiting members 15 are inserted into the limiting holes 12 through the through holes 321, securing the data storage device 10 in the mounting device 100. A bottom surface of the data storage device 10 contacts the circuit board 20 through the recess 41.

In disassembly of the data storage device 10, the limiting members 15 are removed from the case 30 and the data storage device 10, the data storage device 10 is pushed away from the connector 21 through the cutout 331 until the connecting port 11 is disengaged from the connector 21 and a part of the data storage device 10 is located in the yielding portion 415. Thus, the data storage device 10 can be removed from the case 30 via the yielding portion 415.

The embodiments shown and described above are only examples. Many details are often found in the art such as the other features of a mounting device for data storage device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A mounting device for a data storage device comprising:
a cover having a recess; and
a case comprising a top plate and two side plates extending from the top plate;
wherein the top plate and the two side plates cooperate to define a receiving space;
wherein the case further defines an opening, and the data storage device is mountable within the receiving space from the opening with a bottom surface of the data storage device being received into the recess.

2. The mounting device of claim 1, wherein the case further comprises a blocking plate extending from the top plate and configured to block the data storage device, the blocking plate is opposite to the opening, and a length of the blocking plate is less than a distance between the two side plates.

3. The mounting device of claim 2, wherein a cutout is defined between a side of the blocking plate and one of the two side plates, for push the data storage device expediently through.

4. The mounting device of claim 1, wherein a length of the recess is greater than a length of the top plate, the recess has a yielding portion exposed out of the case and located outside the case.

5. The mounting device of claim 1, wherein the top plate defines a plurality of ventilation holes.

6. The mounting device of claim 1, wherein the case further comprises a flange extending perpendicularly from a bottom edge of each side plate, and the flange abuts against and is secured to the cover.

7. The mounting device of claim 6, wherein the cover defines a plurality of positioning holes surrounding the recess, the flange defines a plurality of locking holes, and a plurality of fasteners are inserted into the positioning holes via the locking holes to secure the case to the cover.

8. The mounting device of claim 1, wherein the circuit board further comprises a connector, the data storage device has a connecting port, and the connector is coupled to the connecting port when the data storage device is mounted in the receiving space.

9. The mounting device of claim 1, wherein the circuit board further has two guiding ribs, the two guiding ribs are substantially parallel to each other, and two guiding ribs are configured to guide the data storage device to move therebetween.

10. The mounting device of claim 9, wherein each guiding rib is elastically deformable, when a height of each guiding rib is greater than a height of the data storage device, the guiding ribs are pressed in a same height with the data storage device by the case.

11. A mounting device for a data storage device comprising:
a cover having a recess; and
a case comprising a top plate and two side plates extending from the top plate;
wherein the top plate and the two side plates cooperate to define a receiving space;
wherein the case further defines an opening in a first side of the receiving space and a cutout in a second side, opposite to the first side, of the receiving space, the data storage device is mountable within the receiving space from the opening with a bottom surface of the data storage device received into the recess, and the data storage device is removable from the receiving space by pushing via the cutout.

12. The mounting device of claim 11, wherein the case further comprises a blocking plate extending from the top plate and configured to block the data storage device, the blocking plate is opposite to the opening, and a length of the blocking plate is less than a distance between the two side plates.

13. The mounting device of claim 12, wherein the cutout is defined between a side of the blocking plate and one of the two side plates.

14. The mounting device of claim 11, wherein a length of the recess is greater than a length of the top plate, the recess has a yielding portion exposed out of the case and located outside the case.

15. The mounting device of claim 11, wherein the top plate defines a plurality of ventilation holes.

16. The mounting device of claim 11, wherein the case further comprises a flange extending perpendicularly from a bottom edge of each side plate, and the flange abuts against and is secured to the cover.

17. The mounting device of claim 16, wherein the cover defines a plurality of positioning holes surrounding the recess, the flange defines a plurality of locking holes, and a plurality of fasteners are inserted into the positioning holes via the locking holes to secure the case to the cover.

18. The mounting device of claim 11, wherein the circuit board further comprises a connector, the data storage device has a connecting port, and the connector is coupled to the connecting port when the data storage device is mounted in the receiving space.

19. The mounting device of claim 11, wherein the circuit board further has two guiding ribs, the two guiding ribs are substantially parallel to each other, and two guiding ribs are configured to guide the data storage device to move therebetween.

20. The mounting device of claim 19, wherein each guiding rib is elastically deformable, when a height of each guiding rib is greater than a height of the data storage device, the guiding ribs are pressed in a same height with the data storage device by the case.
